(19) United States
(12) Patent Application Publication
(10) Pub. No.: US 2013/0151898 A1
(43) Pub. Date: Jun. 13, 2013

(54) ELECTRONIC CONNECTION QUALITY TEST DEVICE FOR UNIVERSAL SERIAL BUS INTERFACES

(71) Applicant: ZUO-LIN HOU, Shenzhen City (CN)

(72) Inventor: ZUO-LIN HOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/447,290

(22) Filed: Apr. 16, 2012

(30) Foreign Application Priority Data
Dec. 8, 2011 (CN) 201110405834.7

(51) Int. Cl. G06F 11/273

(52) U.S. Cl. 714/27; 714/E11.171

(57) ABSTRACT

An electronic connection quality test device includes a plurality of test circuits, a hot plug circuit, and a control circuit. The test circuits are respectively electrically connected to a plurality of universal serial bus (USB) interfaces. The hot plug circuit is electrically connected to each of the test circuits and a USB device. The control circuit is electrically connected to each of the test circuits and controls the test circuits to electrically connect selected ones of the USB interfaces with the USB device via the test circuits and the hot plug circuit, thereby forming tested electronic connections between the selected ones of the USB interfaces and the USB device.

### BACKGROUND

1. Technical Field

The present disclosure relates to universal serial bus (USB) interfaces, and particularly to an electronic connection quality test device for USB interfaces.

2. Description of Related Art

When electronic connection quality of a universal serial bus (USB) interface is tested, various types of USB devices (e.g., mice, keyboards, USB flash drives, etc.) may be connected in turn to the USB interface. When a USB device is connected to the USB interface, the USB device is activated, and thus relative parameters (e.g., current and electric potentials) of the electronic connection between the USB device and the USB interface can be measured. In this way, electronic connection quality of the USB interface corresponding to this USB device is tested. However, when a large number of USB interfaces needs electronic connection quality tests (e.g., during actual production), the various types of USB devices may need to be individually connected to and disconnected from each of the USB interfaces, which may cost much time and adversely affect test efficiency.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of an electronic connection quality test device for universal serial bus (USB) interfaces, according to an exemplary embodiment.

FIG. 2 is a circuit diagram of a control circuit of the electronic connection quality test device shown in FIG. 1.

FIG. 3 is a circuit diagram of test circuits of the electronic connection quality test device shown in FIG. 1.

### DETAILED DESCRIPTION

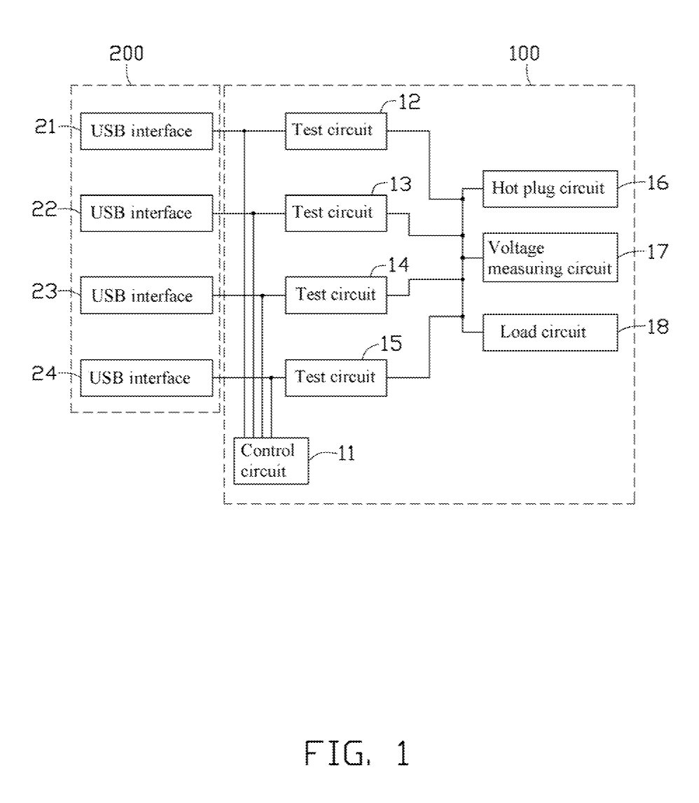

FIG. 1 shows an electronic connection quality test device 100 for universal serial bus (USB) interfaces, according to an exemplary embodiment. The electronic quality test device 100 can test electronic connection quality of a plurality of USB interfaces. In this embodiment, a tested electronic device 200, such as a main board of a computer (PC), includes a plurality of USB interfaces 21, 22, 23, 24. When the USB interfaces 21-24 are all electrically connected to the electronic quality test device 100, the electronic quality test device 100 tests electronic connection quality of the USB interfaces 21-24.

The electronic quality test device 100 includes a control circuit 11, a plurality of test circuits 12, 13, 14, 15 corresponding to the USB interfaces 21-24, a hot plug circuit 16, a voltage measuring circuit 17, and a load circuit 18. The test circuits 12-15 are electrically connected to the USB interfaces 21-24 correspondingly, and each of the test circuits 12-15 is electrically connected to the control circuit 11, the hot plug circuit 16, the voltage measuring circuit 17, and the load circuit 18.

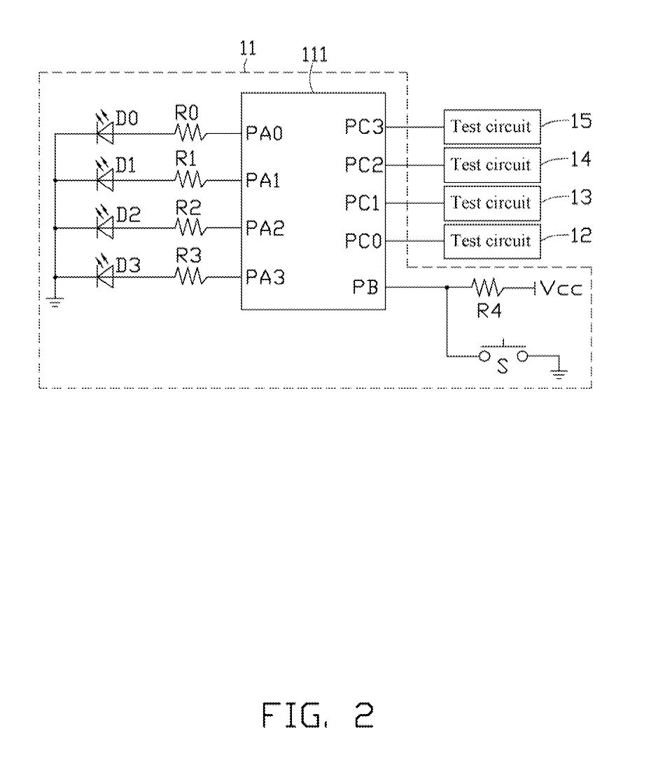

In FIG. 2, the control circuit 11 includes a controller chip 111, a control switch S, a power supply Vcc, a plurality of light emitting diodes (LEDs) D0, D1, D2, D3, and a plurality of resistors R0, R1, R2, R3, R4. The controller chip 111 can be an MK7A20P chip, which includes four control pins PC0, PC1, PC2, PC3, four indication pins PA0, PA1, PA2, PA3, and a switch pin PB. The four control pins PC0-PC3 respectively correspond to the four indication pins PA0-PA3. The control pins PC0-PC3 are respectively electrically connected to the test circuits 12-15. The indication pins PA0-PA3 are electrically connected to anodes of the LEDs D0-D3 via the resistors R0, R1, R2, R3, correspondingly. Cathodes of the LEDs D0-D3 are all grounded. The switch pin PB is electrically connected to the power supply Vcc via the resistor R4. The control switch S is electrically connected between the switch pin PB and the ground. Operating the control switch S can activate the controller chip 111 to work.

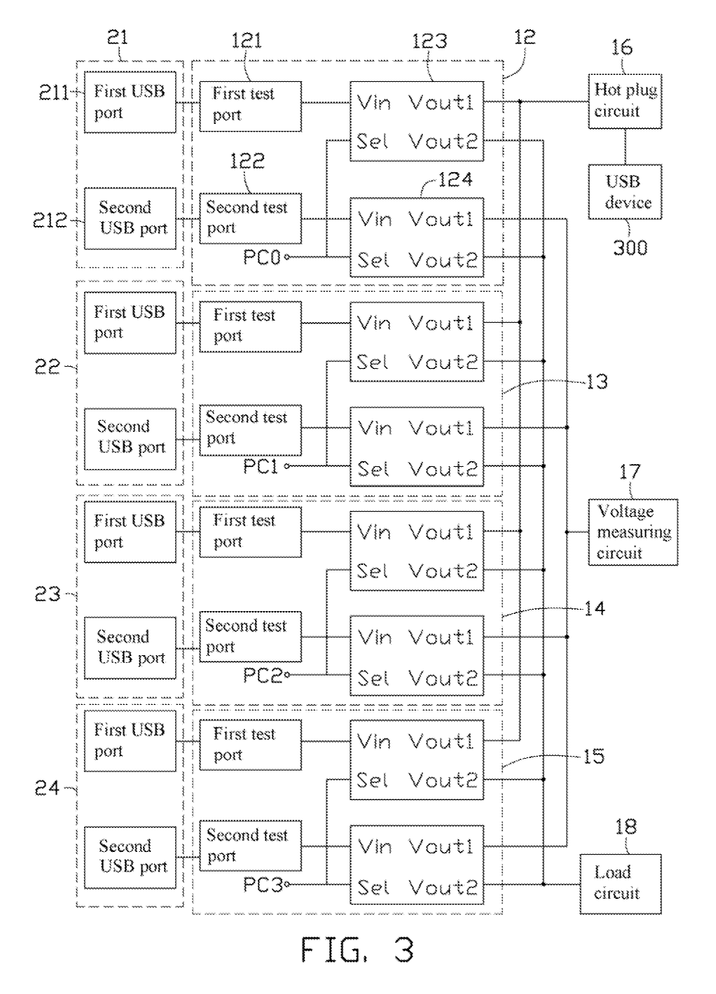

In FIG. 3, the test circuit 12 includes a first test port 121, a second test port 122, a first selector switch 123, and a second selector switch 124. The first selector switch 123 and the second selector switch 124 each include an input pin Vin, a first output pin Vout1, a second output pin Vout2, and a selection pin Sel. In each of the first selector switch 123 and the second selector switch 124, electric potentials applied on the selection pin Sel can control the input pin Vin to be electrically connected to both the first output pin Vout1 and the second output pin Vout2, or to be selectively electrically connected to either the first output pin Vout1 or the second output pin Vout2, and can also separate the input pin Vin from both the first output pin Vout1 and the second output pin Vout2, that is, turn off the selector switch 123/124. The first test port 121 is electrically connected to the input pin Vin of the first selector switch 123, and the second test port 122 is electrically connected to the input pin Vin of the second selector switch 124. The first output pin Vout1 of the first selector switch 123 is electrically connected to the hot plug circuit 16. The first output pin Vout1 of the second selector switch 124 is electrically connected to the voltage measuring circuit 17. Both the second output pins Vout2 of the first selector switch 123 and the second selector switch 124 are electrically connected to the load circuit 18. Both the selection pins Sel of the first selector switch 123 and the second selector switch 124 are electrically connected to the control pin PC0.

Similar to the test circuit 12 and the USB interface 21, each of the test circuits 13, 14, 15 has a first test port, a second test port, a first selector switch, and a second selector switch (not labeled), which are similar to the first test port 121, the second test port 122, the first selector switch 123, and the second selector switch 124, correspondingly. Each of the test circuits 13, 14, 15 is electrically connected to the hot plug circuit 16, the voltage measuring circuit 17, and the load circuit 18 according to methods that are similar to the above-described methods for electrically connecting the interface test circuit 12 with the hot plug circuit 16, the voltage measuring circuit 17, and the load circuit 18. Furthermore, both the selection pins Sel of the first and second selector switches of the test circuit 13 are electrically connected to the control pin PC1, both the selection pins Sel of the first and second selector switches of the test circuit 14 are electrically connected to the control pin PC2, and both the selection pins Sel of the first and second selector switches of the test circuit 15 are electrically connected to the control pin PC3.

Each of the USB interfaces 21-24 can include more than one USB ports. In this embodiment, the USB interface 21 includes a first USB port 211 and a second USB port 212, and each of the USB interfaces 22, 23, 24 has a first USB port and a second USB port (not labeled), too. In use, the first test port 121 is electrically connected to the first USB port 211, and the second test port 122 is electrically connected to the second USB port 212. Each of the test circuits 13, 14, 15 is electrically connected to a corresponding one of the USB interfaces 22, 23, 24 according to methods that are similar to the above-described methods for electrically connecting the interface test circuit 12 with the USB interface 21. Thus, the electronic quality test device 100 can simultaneously test electronic connection quality of the USB interfaces 21-24.

When USB interfaces 21-24 are electrically connected to the electronic quality test device 100, as described above, the control switch S is operated to activate the controller chip 111. The controller chip 111 can selectively test electronic connection quality of any one of the USB interfaces 21-24. For example, if the electronic connection quality of the USB interface 21 is tested, the controller chip 111 sends control signals to the selection pins Sel of the first and second selector switches 123, 124 of the test circuit 12, so that the input pin Vin of the first selector switch 123 is electronically connected to both the first and second output pins Vout1, Vout2 of the first selector switch 123, and the input pin Vin of the second selector switch 124 is electronically connected to both the first and second output pins Vout1, Vout2 of the second selector switch 124. At the same time, the controller chip 111 sends control signals to the selection pins Sel of the first and second selector switches of the test circuits 13-15 to turn off the first and second selector switches of the test circuits 13-15.

As detailed above, the first USB port 211 of the USB port 21 is electrically connected to the load circuit 18 via the first test port 121 and the first selector switch 123, and the second USB port 212 of the USB port 21 is electrically connected to the load circuit 18 via the second test port 122 and the second selector switch 124. The hot plug circuit 16 is electrically connected to the USB device 300 having a predetermined type, such as a mouse, a keyboard, or a USB flash drive. Thus, the USB device 300 is activated to work, and thus relative parameters (e.g., current and electric potentials) of the electronic connection between the USB device 300 and the USB interface 21 can be measured by common methods. The hot plug circuit 16 can also disconnect the first USB port 211 from the USB device 300, such that the effects on the USB interface 21 caused by the disconnection operation can be measured. At the same time, the voltage measuring circuit 17 measures an electric potential output by the second USB port 212, and any interference applied on the second USB port 212 caused by the first USB port 211 can be tested according to the electric potential output by the second USB port 212. During all of the above measurements, the load circuit 18 provides a load adapted to the USB interface 21 to prevent the parameters of the electric connection between the USB device 300 and the USB interface 21 and the electric potential output by the second USB port 212 from being affected by any malfunction of the USB device 300.

When electronic connection quality test of the USB interface 21 is completed, the controller chip 111 can send control signals to the first and second selector switches 123, 124 via the control pin PC0 to turn off the first and second selector switches 123, 124. If electronic connection quality of the USB interface 22/23/24 needs to be tested, the controller chip 111 sends control signals to the first and second selector switches of the test circuit 13/14/15 electrically connected to the USB interface 22/23/24 via the correspondingly control pin PC1/PC2/PC3, and thus electrically connects the input pin Vin of the first selector switch of the test circuit 13/14/15 to both the first and second output pins Vout1, Vout2 of the first selector switch of the test circuit 13/14/15, and connects the input pin Vin of the second selector switch of the test circuit 13/14/15 to both the first and second output pins Vout1, Vout2 of the second selector switch of the test circuit 13/14/15. In this way, the electronic connection quality of the USB interface 22/23/24 can be tested according to methods that are similar to the aforementioned method for test the electronic connection quality of the USB interface 21.

When a different USB interface of the USB interfaces 21/22/23/24 needs to be tested, because the hot plug circuit 16, the USB device 300, the voltage measuring circuit 17, and the load circuit 18 are always electrically connected to the test circuits 12, 13, 14, 15 and different electrical connections to the USB interfaces 21, 22, 23, and 24 can be selected, they do not need to be physically separated from any of the USB interfaces 21, 22, 23, and 24. Therefore, during electronic connection tests for all of the USB interfaces 21, 22, 23, and 24, the electronic quality test device 100 avoids multiple connections and disconnections of the hot plug circuit 16, the USB device 300, the voltage measuring circuit 17, and the load circuit 18. Compared with well-known methods for testing electronic connection quality of USB interfaces, the electronic quality test device 100 can achieve a higher working efficiency.

When any test circuit 12/13/14/15 is used to test the corresponding USB interface 21/22/23/24, the controller chip 111 can send control signals to the indication pin PA0/PA1/PA2/PA3 corresponding to the control pin PC0/PC1/PC2/PC3 which is electrically connected to the particular test circuit 12/13/14/15 being used, and thereby turn on the LED D0/D1/D2/D3 electrically connected to the indication pin PA0/PA1/PA2/PA3 to indicate that one particular test circuit 12/13/14/15 is working. When the test circuit 12/13/14/15 is not used, the controller chip 111 turns off the LED D0/D1/D2/D3.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An electronic connection quality test device, comprising:
a plurality of test circuits configured to be respectively electrically connected to a plurality of universal serial bus (USB) interfaces;
a hot plug circuit electrically connected to each of the test circuits, the hot plug circuit further configured to be electrically connected to a USB device; and
a control circuit electrically connected to each of the test circuits;
wherein the control circuit controls the test circuits to electrically connect selected ones of the USB interfaces with the USB device via the test circuits and the hot plug circuit.

2. The electronic connection quality test device as claimed in claim 1, wherein the control circuit includes a controller chip, the controller chip includes a plurality of control pins corresponding to the test circuits and respectively electrically connected to the test circuits, and the controller chip controls the test circuits to electrically connect selected ones of the tested USB interfaces to the USB device via the test circuits and the hot plug circuit using the control pins.

3. The electronic connection quality test device as claimed in claim 2, wherein the controller chip further includes a plurality of indication pins corresponding to the control pins, and the control circuit further includes a plurality of light emitting diodes (LEDs) corresponding to the indication pins and respectively electrically connected to the indication pins.

4. The electronic connection quality test device as claimed in claim 3, wherein when the controller chip controls the test circuits to electrically connect selected ones of the tested USB interfaces to the USB device via the test circuits and the hot plug circuit using the control pins, the controller chip further turns on the LEDs electrically connected to ones of the indication pins corresponding to ones of the control pins electrically connected to the test circuits which electrically connect the selected ones of the test USB interfaces to the USB device.

5. The electronic connection quality test device as claimed in claim 2, wherein each of the test circuits includes a first test port and a first selector switch, the tested USB interface corresponding to the test circuit is electrically connected to the first selector switch via the first test port, the controller chip is electrically to the first selector switch via the control pin corresponding to the test circuit, and the first selector switch is further electrically connected to the hot plug circuit; and the controller circuit controls the first selector switch to electrically connect the tested USB interface corresponding to the test circuit to the hot plug circuit.

6. The electronic connection quality test device as claimed in claim 5, further comprising a voltage measuring circuit; wherein each of the test circuits further includes a second selector switch, the tested USB interface corresponding to the test circuit is electrically connected to the second selector switch via the second test port, the controller chip is electrically to the second selector switch via the control pin corresponding to the test circuit, and the second selector switch is further electrically connected to the voltage measuring circuit; and the controller circuit controls the second selector switch to electrically connect the tested USB interface corresponding to the test circuit to the voltage measuring circuit.

7. The electronic connection quality test device as claimed in claim 5, further comprising a load circuit electrically connected to both the first and second selector switches of each of the test circuits, and the controller chip controls both the first and second selector switches of each of the test circuits to selectively electrically connect the tested USB interfaces to the load circuit.
